(19) United States
(12) Patent Application Publication
(10) Pub. No.: US 2026/0302233 A1
(43) Pub. Date: Oct. 1, 2026

(54) NEGATIVE ELECTRODE MATERIAL AND PREPARATION METHOD THEREOF, SECONDARY BATTERY, AND ELECTRONIC DEVICE

(71) Applicant: Ningde Amperex Technology Limited, Ningde, Fujian (CN)

(72) Inventor: Yang LI, Ningde (CN)

(73) Assignee: Ningde Amperex Technology Limited, Ningde (CN)

(21) Appl. No.: 19/635,209

(22) Filed: Mar. 31, 2026

(30) Foreign Application Priority Data
Mar. 31, 2025 (CN) 202510396907.2

(51) Int. Cl. H01M 4/587; H01M 10/0569

(52) U.S. Cl. CPC H01M 4/587; H01M 10/0569; H01M 2300/0034; H01M 2300/0042

(57) ABSTRACT

A negative electrode material includes silicon-carbon particles, an oxygen amount of the silicon-carbon particles is X %, where 3≤X≤10, the silicon-carbon particle includes an internal region and a surface region, the surface region refers to a region less than 20 nm from a surface of the silicon-carbon particle, the internal region refers to a region in the silicon-carbon particle other than the surface region, and an oxygen amount in the internal region is X1%, where 3≤X1≤10.

### CROSS-REFERENCE TO RELATED APPLICATION

The present application claims priority to Chinese Patent application No. 202510396907.2 filed in the China National Intellectual Property Administration on Mar. 31, 2025, the entire content of which is hereby incorporated by reference.

### TECHNICAL FIELD

This application relates to the field of electrochemical energy storage, and in particular, to a negative electrode material, a preparation method of the negative electrode material, a secondary battery using the negative electrode material, and an electronic device using the secondary battery.

### BACKGROUND

Lithium-ion batteries have advantages such as high energy density, high operating voltage, good safety, and environmental friendliness, and have been widely used in consumer electronics fields such as mobile phones and laptops. However, negative electrodes of conventional commercial lithium-ion batteries are mainly limited to graphite materials with low capacity (LiC₆, 372 mAh g⁻¹) that significantly hinders improvements in energy density. In recent years, silicon-based materials, with high specific capacity (Li₁₅Si₄, 3579 mAh g⁻¹), abundant resource reserves, and reasonable lithiation platform (<0.4 V vs. Li/Li⁺), have emerged as promising new-generation negative electrode materials for industrial application of negative electrodes of lithium-ion batteries.

Despite these advantages, silicon-based materials undergo significant volume changes during lithiation/delithiation, leading to a decline in cycling performance of lithium-ion batteries and causing pulverization and failure of negative electrode active material particles in the electrode. This hinders the full realization of electrochemical performance of silicon-based materials. To address this issue, according to existing technologies, silicon-based materials are typically nanosized and combined with porous carbon. While particle fracture of the negative electrode active material can be prevented to some extent, swelling performance of secondary batteries still needs improvement in practical applications.

### SUMMARY

This application provides a negative electrode material and a preparation method thereof, a secondary battery, and an electronic device.

A first aspect of this application provides a negative electrode material, where the negative electrode material includes silicon-carbon particles, an oxygen amount of the silicon-carbon particle is X %, where 3≤X≤10, the silicon-carbon particle includes an internal region and a surface region, the surface region refers to a region less than 20 nm from a surface of the silicon-carbon particle, the internal region refers to a region in the silicon-carbon particle other than the surface region, and an oxygen amount in the internal region is X1%, where 3≤X1≤10.

In this application, the oxygen amounts in the silicon-carbon particle and the internal region being within appropriate ranges indicates that the internal region of the silicon-carbon particle uniformly contains oxygen, and the oxygen distribution in the silicon-carbon particle is relatively uniform. The above oxygen in the silicon-carbon particle and the distribution of oxygen amount in the internal region can convert nanosilicon in the silicon-carbon particle into SiOx, reducing the reactivity of a portion of silicon, thereby reducing the extent of reactions between silicon and water, and consequently reducing hydrogen generation caused by the reactions of nanosilicon inside the silicon-carbon particle with water during the preparation of an anode slurry, thus improving the specific capacity and initial coulombic efficiency of the silicon-carbon particle. Meanwhile, the oxygen amount in the internal region being within the above range can further enhance structural stability of the silicon-carbon particle. During charge and discharge of a secondary battery containing silicon-carbon particles, lithiated LiSixOy can further mitigate volume change of silicon, reducing pulverization of the silicon-carbon particles and detachment of electrode materials, thereby improving the swelling performance of the silicon-carbon particles. In addition, under a condition that the secondary battery is fully charged, LiSixOy can suppress the reactions between the electrolyte and the silicon-lithium alloy, reducing the consumption of electrolyte and active lithium, thereby effectively alleviating the cycling swelling of the secondary battery during cycling (ITC cycling) after high-temperature, full-charge storage.

In some possible implementations based on the first aspect, the silicon-carbon particles include porous carbon and silicon particles, and at least part of the silicon particles located within pores of the porous carbon. The porous carbon serves as a framework for the silicon-carbon particles, providing good electrical conductivity and cycling stability for the silicon-carbon particles. In addition, as a matrix for silicon deposition, porous carbon can suppress volume swelling of silicon during lithium intercalation, thereby reducing swelling stress and improving the cycling performance and swelling performance of the silicon-carbon particles.

In some possible implementations based on the first aspect, an oxygen amount in the surface region is X2%, where 2≤X2≤8. The oxygen amount in the surface region being within the above range facilitates the sufficient conversion of nanosilicon in the surface region into SiOx, reducing the extent of reactions between silicon and water, thereby reducing hydrogen generation and further improving the specific capacity and initial coulombic efficiency of the negative electrode material. The oxygen amount being in the above range also facilitates the formation of LiSixOy after lithiation, reducing contact between the electrolyte and silicon-lithium alloy and suppressing the swelling of the silicon-lithium alloy during lithiation, thereby reducing the ITC cycling swelling of the secondary battery.

In some possible implementations based on the first aspect, 0.6≤X1/X2≤ 2.5. A uniform oxygen amount distribution in the silicon-carbon particle facilitates achieving good specific capacity and initial coulombic efficiency of the negative electrode material while further reducing the ITC cycling swelling of the secondary battery.

In some possible implementations based on the first aspect, the oxygen amount of the silicon-carbon particle satisfies: 4≤X≤6 and 3≤X1≤6. This facilitates further improving the specific capacity and initial coulombic efficiency of the negative electrode material and further reducing the ITC cycling swelling of the secondary battery.

In some possible implementations based on the first aspect, A delithiation differential capacity curve of the negative electrode material exhibits a first peak in the range of 200 mV to 320 mV and a second peak in the range of 600 mV to 900 mV, wherein a peak intensity ratio of the first peak to the second peak satisfies is I1, 1.7≤I1≤3.8. This facilitates the conversion of nanosilicon in the silicon-carbon particle into SiOx, reducing the reactivity of a part of silicon, enabling the negative electrode material to have good specific capacity and initial coulombic efficiency, mitigating the volume swelling of silicon, reducing the consumption of electrolyte and active lithium in the fully charged secondary battery, and further reducing the ITC cycling swelling of the secondary battery.

In some possible implementations based on the first aspect, in an X-ray photoelectron spectrum of the silicon-carbon particle, a Si—O peak is present in the range of 101 eV to 104 eV and a Si—Si peak is present in the range of 96 eV to 99 eV, wherein a peak intensity ratio of the Si—O peak to the Si—Si peak is I2, 0.8≤I2≤1.5. This facilitates reducing slurry gas production in the anode slurry preparation, minimizing losses in the initial coulombic efficiency and specific capacity of the silicon-carbon particle. In the fully charged secondary battery, LiSixOy can suppress the reactions between the electrolyte and the silicon-lithium alloy, reducing the consumption of electrolyte and active lithium, thereby mitigating the ITC cycling swelling of the secondary battery.

A second aspect of this application provides a preparation method of silicon-carbon particles in a negative electrode material, including the following steps: (S1) providing a porous carbon scaffold, introducing a silane gas into the porous carbon scaffold, and after silicon deposition on the porous carbon scaffold, sequentially switching the silane gas to a carbon dioxide mixed gas, the silane gas, and the carbon dioxide mixed gas, to obtain a core, where in each introduction process, a flow rate of the carbon dioxide mixed gas is 50 sccm to 300 sccm, an introduction period is 1 h to 20 h, a reaction temperature is 400° C. to 500° C., the carbon dioxide mixed gas includes carbon dioxide and an inert gas, and a mass percentage of carbon dioxide is 2% to 20% of the carbon dioxide mixed gas; and (S2) introducing an alkane gas into the core to form a carbon layer on the core, so as to obtain the silicon-carbon particles. In the above preparation method, a core is formed through alternating deposition with the silane gas and carbon dioxide gas on the porous carbon scaffold. A carbon layer for carbon coating is formed through an alkane, and then silicon-carbon particles are obtained. This preparation process can improve the uniformity of oxygen amount in the internal region and facilitate achieving an appropriate oxygen amount in the silicon-carbon particles, thereby improving the specific capacity and initial coulombic efficiency of the negative electrode material and mitigating the ITC cycling swelling of the secondary battery.

A third aspect of this application provides a secondary battery, including a negative electrode plate, a positive electrode plate, and an electrolyte, where the negative electrode plate further includes the negative electrode material described above or the negative electrode material obtained based on the preparation method described above, and the negative electrode material further includes graphite. Due to the flexibility of graphite, combining graphite with silicon-carbon particles can mitigate the overall volume swelling of the negative electrode material layer. Meanwhile, using both graphite and silicon-carbon particles as the negative electrode material can fully leverage the advantages of both silicon-carbon particles and graphite to achieve better electrochemical performance.

In some possible implementations based on the third aspect, an average circularity of the silicon-carbon particles is C1, an average circularity of particles of the graphite is C2, and |C1−C2|≤0.2. Average circularities of the silicon-carbon particles and graphite being close means small morphological differences between the silicon-carbon particles and graphite, and a low proportion of sharp or irregular regions in the negative electrode material. During the stirring process of anode slurry preparation, this minimizes the impact on the surface layer of the silicon-carbon particles, reducing the exposure of nanosilicon interfaces in the silicon-carbon particles, and reducing the formation of SEI film byproducts, thereby minimizing losses in the initial coulombic efficiency and specific capacity of the silicon-carbon particles, thus improving the initial coulombic efficiency and specific capacity of the negative electrode material and mitigating the ITC cycling swelling of the secondary battery.

In some possible implementations based on the third aspect, the electrolyte includes ethylene carbonate and propylene carbonate, and based on a mass of the electrolyte, a mass percentage of the ethylene carbonate is D1%, and a mass percentage of the propylene carbonate is D2%, where 9≤D1+D2≤35. This facilitates further improving the specific capacity and initial coulombic efficiency of the negative electrode material and reducing the ITC cycling swelling of the secondary battery.

In some possible implementations based on the third aspect, 12≤D1+D2≤25. This can further improve the specific capacity and initial coulombic efficiency of the negative electrode material and reduce the ITC cycling swelling of the secondary battery.

In some possible implementations based on the third aspect, the electrolyte includes ethylene carbonate and fluoroethylene carbonate, and based on a mass of the electrolyte, a mass percentage of the ethylene carbonate is D1%, and a mass percentage of the fluoroethylene carbonate is D3%, where 0.83≤D3/D1≤1.75. This facilitates further improving the specific capacity and initial coulombic efficiency of the negative electrode material and reducing the ITC cycling swelling of the secondary battery.

In some possible implementations based on the third aspect, 1≤D3/D1≤1.5. This can further improve the specific capacity and initial coulombic efficiency of the negative electrode material and reduce the ITC cycling swelling of the secondary battery.

A fourth aspect of this application provides an electronic device, including a secondary battery, where the secondary battery supplies power to a load in the electronic device. The secondary battery including the negative electrode plate has low ITC cycling swelling, helping to prolong a service life of the electronic device.

### DETAILED DESCRIPTION

The technical solutions in the embodiments of this application are described clearly and in detail below. It is clear that the described embodiments are only some but not all embodiments of this application. Unless otherwise defined, all technical and scientific terms used herein have the same meaning as commonly understood by persons skilled in the technical field of this application. The terms used in the specification of this application are only for the purpose of describing specific embodiments and are not intended to limit this application.

In an anode slurry preparation process, a high stirring linear speed can cause friction and collisions between silicon-based material particles and between the particles and a stirring rod/tank wall. After a carbon layer on a surface of the silicon-based material is damaged, nanosilicon inside the silicon-based material reacts with water to produce hydrogen, affecting the specific capacity and initial coulombic efficiency of the silicon-based material, and even impacting subsequent coating, leading to issues such as anode pits or trailing.

In practical applications, silicon-based lithium-ion batteries need to withstand cycling after high-temperature, full-charge storage (ITC cycling). The swelling of silicon-based lithium-ion batteries is greater than that of graphite-based lithium-ion batteries, and high-temperature condition and high-temperature full-charge storage further exacerbate the swelling of lithium-ion batteries. Therefore, suppressing gas production during anode slurry preparation and reducing ITC swelling are critical for the application of silicon-based lithium-ion batteries.

Therefore, an embodiment of this application provides a secondary battery including a shell, an electrode assembly, and an electrolyte. The electrode assembly and the electrolyte are both located within the shell.

The shell may be a packaging obtained by encapsulation with a packaging film (for example, an aluminum-plastic film). For example, a secondary battery is a pouch cell. In some other embodiments, the secondary battery may alternatively be a steel-shell battery, an aluminum-shell battery, or the like.

The electrode assembly includes a positive electrode plate, a negative electrode plate, and a separator, where the separator is disposed between the positive electrode plate and the negative electrode plate. The electrode assembly may be a stacked structure formed by alternately stacking the positive electrode plate, the separator, and the negative electrode plate. In some other embodiments, the electrode assembly may alternatively be a wound structure formed by stacking and winding the positive electrode plate, the separator, and the negative electrode plate.

### Negative Electrode Plate

The negative electrode plate includes a negative electrode current collector and a negative electrode material layer disposed on at least one surface of the negative electrode current collector. The negative electrode current collector may use at least one of copper foil, nickel foil, stainless steel foil, titanium foil, a composite current collector, or a carbon-based current collector. The negative electrode material layer includes a negative electrode material.

An embodiment of this application provides a negative electrode material, where the negative electrode material includes silicon-carbon particles; an oxygen amount of the silicon-carbon particle is X %, where 3≤X≤10; the silicon-carbon particle includes an internal region and a surface region; the surface region refers to a region less than 20 nm from a surface of the silicon-carbon particle; the internal region refers to a region in the silicon-carbon particle other than the surface region; and an oxygen amount in the internal region is X1%, where 3≤X1≤10.

In this application, the oxygen amounts in the silicon-carbon particle and the internal region being within appropriate ranges indicates that the internal region of the silicon-carbon particle uniformly contains oxygen, and the oxygen amount distribution in the silicon-carbon particle is relatively uniform. The above oxygen in the silicon-carbon particle and the distribution of oxygen amount in the internal region can convert nanosilicon in the silicon-carbon particle into SiOx, reducing the reactivity of a portion of silicon, thereby reducing the extent of reactions between silicon and water, and consequently reducing hydrogen generation due to reactions of nanosilicon inside the silicon-carbon particle with water during the preparation of an anode slurry, thus improving the specific capacity and initial coulombic efficiency of the silicon-carbon particle. Meanwhile, the oxygen amount in the internal region being within the above range can further enhance structural stability of the silicon-carbon particle. During charge and discharge of a secondary battery containing silicon-carbon particles, lithiated LiSixOy can further mitigate volume change of silicon, reducing pulverization of the silicon-carbon particles and detachment of electrode materials, thereby improving the swelling performance of the silicon-carbon particles. In addition, under a condition that the secondary battery is fully charged, LiSixOy can suppress the reactions between the electrolyte and the silicon-lithium alloy, reducing the consumption of electrolyte and active lithium, thereby effectively alleviating the cycling swelling of the secondary battery during cycling (ITC cycling) after full-charge storage.

If the oxygen amount in the silicon-carbon particle or the internal region is low, such as less than 3, a portion of nanosilicon in the silicon-carbon particle may not be converted into SiOx. During anode slurry preparation, exposed nanosilicon is prone to reacting with water to produce hydrogen, which reduces the initial coulombic efficiency and specific capacity of the negative electrode material and increases a possibility of pits or trailing during anode coating. In addition, a low oxygen amount makes it difficult to fully convert nanosilicon into SiOx, resulting in insufficient LiSixOy formation during charge and discharge of the secondary battery. This is not conducive to mitigating the ITC cycling swelling of the secondary battery.

If the oxygen amount in the silicon-carbon particle or the internal region is high, such as greater than 10, a high oxygen amount leads to more LiSixOy during lithiation, increasing first-cycle irreversible lithium consumption in the negative electrode material, which reduces the specific capacity and initial coulombic efficiency of the negative electrode material. A high oxygen amount is also not conducive to mitigating the ITC cycling swelling of the secondary battery.

In some embodiments, the oxygen amount X of the silicon-carbon particle may be 3, 4, 5, 6, 7, 8, 9, or 10, or may be any value within a range defined by any two of the above values.

In some embodiments, the oxygen amount X1 of the internal region of the silicon-carbon particle may be 3, 4, 5, 6, 7, 8, 9, or 10, or may be any value within a range defined by any two of the above values.

In some embodiments, the silicon-carbon particles include porous carbon and silicon particles, and at least part of the silicon particles located within pores of the porous carbon. The porous carbon serves as a framework for the silicon-carbon particles, providing good electrical conductivity and cycling stability for the silicon-carbon particles. In addition, as a matrix for silicon deposition, porous carbon can suppress volume swelling of silicon during lithium intercalation, thereby reducing swelling stress and improving the cycling performance and swelling performance of the silicon-carbon particles. In some embodiments, part of silicon particles may be located within the pores of the porous carbon, while other silicon particles may be located on a surface of the porous carbon.

In some embodiments, the oxygen amount in the surface region is X2%, where 2≤X2≤8. The oxygen amount in the surface region being within the above range facilitates the sufficient conversion of nanosilicon in the surface region into SiOx, reducing the extent of reactions between silicon and water due to large shear forces during anode slurry preparation, thereby reducing hydrogen generation and further improving the specific capacity and initial coulombic efficiency of the negative electrode material. The oxygen amount being in the above range also facilitates the formation of lithiated LiSixOy, reducing contact between the electrolyte and the internal silicon-lithium alloy and suppressing the swelling of the silicon-lithium alloy during lithiation, thereby reducing the ITC cycling swelling of the secondary battery. In some embodiments, the oxygen amount X2 in the surface region of the silicon-carbon particle may be 2, 3, 4, 5, 6, 7, or 8, or may be any value within a range defined by any two of the above values.

In some embodiments, 0.6≤X1/X2≤2.5. In the silicon-carbon particle, the ratio of oxygen amounts in the surface region and the internal region can reflect uniformity of oxygen amount distribution between the internal region and the surface region. When the oxygen amounts in the internal region and the surface region of the silicon-carbon particle satisfies the above ranges, the oxygen amount distribution in the silicon-carbon particle is uniform. This facilitates achieving good specific capacity and initial coulombic efficiency of the negative electrode material while further reducing the ITC cycling swelling of the secondary battery. In some embodiments, the ratio X1/X2 may be 0.6, 0.7, 0.8, 0.9, 1.2, 1.4, 1.5, 1.8, 2, 2.3, or 2.5, or may be any value within a range defined by any two of the above values.

In some embodiments, the oxygen amount of the silicon-carbon particle satisfies: 4≤X≤6 and 3≤X1≤6. This facilitates further improving the specific capacity and initial coulombic efficiency of the negative electrode material and further reducing the ITC cycling swelling of the secondary battery.

In some embodiments, a delithiation differential capacity curve of the negative electrode material exhibits a first peak in the range of 200 mV to 320 mV and a second peak in the range of 600 mV to 900 mV, wherein a peak intensity ratio of the first peak to the second peak satisfies is I1, 1.7≤I1≤3.8. The differential capacity-voltage curve of the negative electrode material during delithiation may be understood as follows. The charge-discharge specific capacity of the negative electrode material is used as abscissa and voltage is used as ordinate, and then the charge-discharge curve of the negative electrode material is obtained. The first derivative of a delithiation specific capacity of the negative electrode material with respect to voltage is used as the ordinate and voltage is used as the abscissa, and then the differential capacity-voltage curve of the negative electrode material during delithiation is obtained. The differential capacity-voltage curve can reflect a capacity of the negative electrode material within a unit voltage range. If a capacity at a specific voltage plateau is high, it means that a small voltage fluctuation range contributes a significant amount of capacity, which manifests as a characteristic peak on the curve. Each characteristic peak represents an electrochemical reaction, and a height of each characteristic peak indicates a magnitude of capacity contribution of the corresponding electrochemical reaction.

The first peak of the negative electrode material is a delithiation characteristic peak for the transition from LixSi (x is approximately 3.5) to LiySi (y is approximately 2); and the second peak is a partially reversible delithiation characteristic peak for the transition from LiSixOy to SiOx. The ratio of the first peak to the second peak can reflect the impact of oxygen amount in the negative electrode material on the delithiation reactions of the negative electrode material. When I1 is within the above range, it indicates an appropriate oxygen amount in the negative electrode material, which facilitates the conversion of nanosilicon in the silicon-carbon particle into SiOx, reducing the reactivity of a portion of silicon, enabling the negative electrode material to have good specific capacity and initial coulombic efficiency, mitigating the volume swelling of silicon, reducing the consumption of electrolyte and active lithium in the fully charged secondary battery, and further reducing the ITC cycling swelling of the secondary battery. In some embodiments, I1 may be 1.7, 1.9, 2.0, 2.3, 2.5, 2.7, 3.0, 3.5, or 3.8, or may be any value within a range defined by any two of the above values.

In some embodiments, in an X-ray photoelectron spectrum of the silicon-carbon particle, a Si—O peak is present in the range of 101 eV to 104 eV and a Si—Si peak is present in the range of 96 eV to 99 eV, wherein a peak intensity ratio of the Si—O peak to the Si—Si peak is I2, 0.8≤I2≤1.5. In the X-ray photoelectron spectroscopy, the intensity of the Si—O peak at 101 eV to 104 eV can reflect an amount proportion of SiOx in the surface region of the silicon-carbon particle, and the intensity of the Si—Si peak at 96 eV to 99 eV can reflect an amount proportion of Si in the surface region of the silicon-carbon particle. When the peak intensity ratio 12 is within the above appropriate range, it facilitates reducing slurry gas production in the anode slurry preparation, minimizing losses in the initial coulombic efficiency and specific capacity of the silicon-carbon particle. In the fully charged secondary battery, LiSixOy can suppress the reactions between the electrolyte and the silicon-lithium alloy, reducing the consumption of electrolyte and active lithium, thereby mitigating the ITC cycling swelling of the secondary battery. In some embodiments, 12 may be 0.8, 0.9, 1.0, 1.1, 1.2, 1.3, 1.4, or 1.5, or may be any value within a range defined by any two of the above values.

In some embodiments, the negative electrode material further includes graphite, an average circularity of the silicon-carbon particles is C1, and an average circularity of particles of the graphite is C2, where |C1−C2|≤0.2. The negative electrode material includes graphite, where the graphite includes at least one of natural graphite or artificial graphite. Due to the flexibility of graphite, combining graphite with silicon-carbon particles can mitigate the overall volume swelling of the negative electrode material layer. Meanwhile, using both graphite and silicon-carbon particles as the negative electrode material can fully leverage the advantages of both silicon-carbon particles and graphite to achieve better electrochemical performance. The inventors have found that smaller |C1−C2| means closer average circularities of the silicon-carbon particles and graphite, smaller morphological differences between the silicon-carbon particles and graphite, and a lower proportion of sharp or irregular regions in the negative electrode material. During the stirring process of anode slurry preparation, this facilitates reducing friction and collisions between silicon-carbon particles in the negative electrode material, and between silicon-carbon particles and the stirring rod/tank wall, minimizing the impact on the surface layer of the silicon-carbon particles, reducing the exposure of nanosilicon interfaces in the silicon-carbon particles, and reducing the formation of SEI film byproducts, thereby reducing gas production and minimizing losses in the initial coulombic efficiency and specific capacity of the silicon-carbon particles, thus improving the initial coulombic efficiency and specific capacity of the negative electrode material and mitigating the ITC cycling swelling of the secondary battery. In some embodiments, the value of |C1−C2| may be 0, 0.05, 0.1, 0.15, 0.2, or may be any value within a range defined by any two of the above values. In some embodiments, |C1−C2|≤0.1.

In some embodiments, the electrolyte includes ethylene carbonate and propylene carbonate, and based on a mass of the electrolyte, a mass percentage of the ethylene carbonate is D1%, and a mass percentage of the propylene carbonate is D2%, where 9≤D1+D2≤35. The inclusion of ethylene carbonate and propylene carbonate in the electrolyte facilitates improving the specific capacity and initial coulombic efficiency of the negative electrode material and reducing the ITC cycling swelling of the secondary battery. A sum of the amounts of ethylene carbonate and propylene carbonate being within the above range facilitates further improving the specific capacity and initial coulombic efficiency of the negative electrode material and reducing the ITC cycling swelling of the secondary battery. In some embodiments, a sum of D1+D2 may be 9, 10, 11, 12, 15, 18, 20, 23, 25, 27, 30, 32, or 35, or may be any value within a range defined by any two of the above values. In some embodiments, 12≤D1+D2≤25.

In some embodiments, the electrolyte includes ethylene carbonate and fluoroethylene carbonate, and based on a mass of the electrolyte, a mass percentage of the ethylene carbonate is D1%, and a mass percentage of the fluoroethylene carbonate is D3%, where 0.83≤D3/D1≤1.75. The inclusion of ethylene carbonate and fluoroethylene carbonate in the electrolyte facilitates improving the specific capacity and initial coulombic efficiency of the negative electrode material and reducing the ITC cycling swelling of the secondary battery. The amount ratio of fluoroethylene carbonate to ethylene carbonate being within the above range facilitates further improving the specific capacity and initial coulombic efficiency of the negative electrode material and reducing the ITC cycling swelling of the secondary battery. In some embodiments, the ratio D3/D1 may be 0.83, 0.9, 1.0, 1.1, 1.2, 1.3, 1.4, 1.5, 1.6, 1.7, or 1.75, or may be any value within a range defined by any two of the above values. In some embodiments, 1.0≤D3/D1≤1.5.

This application further provides a preparation method of silicon-carbon particles in a negative electrode material, including the following steps.

(S1) Provide a porous carbon scaffold, introduce a silane gas into the porous carbon scaffold, and after silicon deposition on the porous carbon scaffold, sequentially switch the silane gas to a carbon dioxide mixed gas, the silane gas, and the carbon dioxide mixed gas, to obtain a core.

This step specifically includes the following implementations.

At a temperature of 400° C. to 500° C., the porous carbon scaffold is subjected to deposition in a silane mixed gas for 1 h to 20 h. Then the gas source is switched to a carbon dioxide mixed gas for oxidation for 1 h to 20 h. The above operations were repeated twice to form a deposition cycle of “silane-carbon dioxide oxidation-silane-carbon dioxide oxidation”, so as to obtain a core.

In some embodiments, a temperature for each silicon deposition on the porous carbon scaffold may be 400° C., 430° C., 450° C., 470° C., or 500° C., or may be any value within a range defined by any two of the above values. The time for each silicon deposition may be 1 h, 2 h, 5 h, 7 h, 8 h, 10 h, 12 h, 14 h, 15 h, 17 h, 19 h, or 20 h, or may be any value within a range defined by any two of the above values.

In some embodiments, a temperature for each carbon dioxide mixed gas oxidation deposition of silicon on the porous carbon scaffold may be 400° C., 430° C., 450° C., 470° C., or 500° C., or may be any value within a range defined by any two of the above values. The time for each carbon dioxide mixed gas oxidation may be 1 h, 2 h, 5 h, 7 h, 8 h, 10 h, 12 h, 14 h, 15 h, 17 h, 19 h, or 20 h, or may be any value within a range defined by any two of the above values.

A heating rate for slow heating may be, but is not limited to, 0.5° C./min to 5° C./min. The silane mixed gas includes 2% to 20% of silane by mass and 80% to 98% of inert gas (such as, but not limited to, argon), and a flow rate of the silane mixed gas is 100 sccm to 500 sccm. In some embodiments, the flow rate of the silane mixed gas may be 100 sccm, 150 sccm, 200 sccm, 300 sccm, 400 sccm, or 500 sccm, or may be any value within a range defined by any two of the above values.

The carbon dioxide mixed gas includes 2% to 20% of carbon dioxide by mass and 80% to 98% of an inert gas (such as, but not limited to, argon). A flow rate of the carbon dioxide mixed gas is 50 sccm to 300 sccm. In some embodiments, the flow rate of the carbon dioxide mixed gas may be 50 sccm, 100 sccm, 150 sccm, 200 sccm, or 300 sccm, or may be any value within a range defined by any two of the above values.

In the above steps, the silane mixed gas is introduced, and in the silane mixed gas atmosphere, the silane mixed gas deposits silicon on the porous carbon scaffold for the first time. Then, the silane mixed gas atmosphere is switched to a carbon dioxide mixed gas, and the carbon dioxide mixed gas oxidizes the porous carbon scaffold that undergoes silicon deposition for the first time, improving the uniformity of oxygen amount distribution within the porous carbon scaffold and increasing the oxygen amount. Subsequently, the carbon dioxide mixed gas is switched to the silane mixed gas, and in the silane mixed gas atmosphere, the silane mixed gas deposits silicon on the porous carbon scaffold for the second time. Finally, the silane mixed gas is switched to a carbon dioxide mixed gas, and the carbon dioxide mixed gas oxidizes the porous carbon scaffold that undergoes two silicon depositions for the second time. In this way, the core is obtained. The temperatures for the two carbon dioxide oxidation processes, periods of the carbon dioxide introduction, and flow rates of the carbon dioxide introduction of the porous carbon scaffold may be the same.

In the above process, in the first oxidation process, a mass percentage, a flow rate, a period, and a reaction temperature for introducing carbon dioxide all affect the oxygen amount X of the silicon-carbon particle and the oxygen amount X1 of the internal region. A higher carbon dioxide amount, a longer period, a higher temperature, and a greater flow rate all facilitate increasing the oxygen amount in the internal region of the silicon-carbon particle. In the second oxidation process, a mass percentage, a flow rate, a period, and a reaction temperature of the introduced carbon dioxide all affect the oxygen amount X2 in the surface region of the silicon-carbon particle. A higher carbon dioxide amount, a longer period, a higher temperature, or a greater flow rate all facilitate increasing the oxygen amount in the surface region of the silicon-carbon particle.

(S2) Introduce an alkane gas into the core to form a carbon layer on the core, so as to obtain the silicon-carbon particles.

Specifically, at a temperature of 500° C. to 1000° C., the carbon dioxide atmosphere is switched to an alkane mixed gas; the gas is maintained for 2 h to 20 h to form a carbon coating layer, which is a carbon layer, covering the core; and the alkane mixed gas atmosphere is switched to an inert atmosphere (such as, but not limited to, a nitrogen atmosphere) and cooled to room temperature. In this way, the silicon-carbon particles are obtained. The alkane mixed gas includes 5% to 100% of alkane (such as, but not limited to, acetylene) by mass and 0% to 95% of inert gas (such as, but not limited to, argon). A flow rate of the alkane mixed gas is 100 sccm to 500 sccm. In some embodiments, the flow rate of the alkane mixed gas may be 100 sccm, 150 sccm, 200 sccm, 300 sccm, 400 sccm, or 500 sccm, or may be any value within a range defined by any two of the above values.

The negative electrode material layer further includes a binder and a conductive agent. The binder is used to bind the negative electrode material particles to facilitate the formation of a film layer and also to enhance bonding between the negative electrode material layer and the negative electrode current collector. In some embodiments, the binder may include, but is not limited to, polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly(1,1-difluoroethylene), polyethylene, polypropylene, styrene-butadiene rubber, acrylated styrene-butadiene rubber, epoxy resin, or nylon.

The negative electrode material layer comprises the conductive agent. The conductive agent includes, but is not limited to, a carbon-based material, metal-based material, conductive polymer, or any combination thereof. In some embodiments, the carbon-based material may include, but is not limited to, natural graphite, artificial graphite, carbon black, acetylene black, Ketjen black, carbon fiber, or any combination thereof. In some embodiments, the metal-based material may include, but is not limited to, metal powder or metal fiber, such as copper, nickel, aluminum, or silver. In some embodiments, the conductive polymer may be a polyphenylene derivative.

### Separator

A material and shape of the separator used in the secondary battery of this application are not particularly limited and may be any technology disclosed in the prior art. In some embodiments, the separator includes a polymer or inorganic substance formed from a material stable to the electrolyte of this application.

For example, the separator may include a substrate layer and a surface treatment layer. The substrate layer is a non-woven fabric, film, or composite film with a porous structure, and a material of the substrate layer is selected from at least one of polyethylene, polypropylene, polyethylene terephthalate, and polyimide. Specifically, a polypropylene porous film, a polyethylene porous film, a polypropylene non-woven fabric, a polyethylene non-woven fabric, or a polypropylene-polyethylene-polypropylene porous composite film may be used.

A surface treatment layer is provided on at least one surface of the substrate layer, and the surface treatment layer may be a polymer layer or an inorganic layer, or a layer formed by mixing a polymer and an inorganic substance. The inorganic layer includes inorganic particles and a binder, where the inorganic particles are selected from at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is selected from at least one of polyvinylidene fluoride, a copolymer of vinylidene fluoride-hexafluoropropylene, polyamide, polyacrylonitrile, polyacrylate, polyacrylic acid, polyacrylate salt, polyvinylpyrrolidone, polyvinylalkylether, poly(methyl methacrylate), polytetrafluoroethylene, or polyhexafluoropropylene. The polymer layer includes a polymer, and a material of the polymer is selected from at least one of polyamide, polyacrylonitrile, acrylate polymer, polyacrylic acid, polyacrylate salt, polyvinylpyrrolidone, polyvinylalkylether, polyvinylidene fluoride, or poly(vinylidene fluoride-hexafluoropropylene).

### Electrolyte

According to some embodiments of this application, the electrolyte includes an organic solvent, a lithium salt, and an optional additive. The organic solvent in the electrolyte of this application may be any organic solvent known in the prior art that can be used as an electrolyte solvent. The electrolyte used in the electrolyte of this application is not limited and may be any electrolyte known in the prior art. The additive in the electrolyte of this application may be any additive known in the prior art that can be used as electrolyte additive.

In some embodiments, the organic solvent includes, but is not limited to, ethylene carbonate (EC), propylene carbonate (PC), diethyl carbonate (DEC), ethyl methyl carbonate (EMC), dimethyl carbonate (DMC), propylene carbonate, or ethyl propionate. In some embodiments, the organic solvent includes an ether solvent, such as at least one of 1,3-dioxolane (DOL) or ethylene glycol dimethyl ether (DME). In some embodiments, the lithium salt includes at least one of an organic lithium salt or an inorganic lithium salt. In some embodiments, the lithium salt includes, but is not limited to, lithium hexafluorophosphate (LiPF₆), lithium tetrafluoroborate (LiBF₄), lithium difluorophosphate (LiPO₂F₂), lithium bis(trifluoromethanesulfonyl)imide LiN(CF₃SO₂)₂ (LiTFSI), lithium bis(fluorosulfonyl)imide LiN(SO₂F)₂ (LiFSI), lithium bis(oxalato) borate LiB(C₂O₄)₂ (LiBOB), or lithium difluoro (oxalato) borate LiBF₂(C₂O₄) (LiDFOB). In some embodiments, the additive includes at least one of fluoroethylene carbonate or adiponitrile.

### Positive Electrode Plate

The positive electrode plate includes a positive electrode current collector and a positive electrode active layer disposed on the positive electrode current collector. The positive electrode current collector may be aluminum foil or nickel foil. The positive electrode active layer includes a positive electrode active material, and the positive electrode active material includes a compound capable of reversibly intercalating and deintercalating lithium ions (that is, lithiated intercalation compound). In some embodiments, the positive electrode active material may include a lithium transition metal composite oxide. The lithium transition metal composite oxide contains lithium and at least one element selected from cobalt, manganese, and nickel. In some embodiments, the positive electrode active material may include, but is not limited to, at least one of lithium cobalt oxide, lithium nickel manganese cobalt oxide, lithium nickel manganese aluminum oxide, lithium iron phosphate, lithium vanadium phosphate, lithium cobalt phosphate, lithium manganese phosphate, lithium manganese iron phosphate, lithium iron silicate, lithium vanadium silicate, lithium cobalt silicate, lithium manganese silicate, spinel-type lithium manganese oxide, spinel-type lithium nickel manganese oxide, or lithium titanate.

The positive electrode active layer further includes a binder to bind the positive electrode active material particles to facilitate the formation of a film layer and to enhance bonding between the positive electrode active layer and the positive electrode current collector. In some embodiments, the binder may include, but is not limited to, at least one of polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly(1,1-difluoroethylene), polyethylene, polypropylene, styrene-butadiene rubber, acrylated styrene-butadiene rubber, epoxy resin, or nylon.

The positive electrode active layer may further include a conductive material, where the conductive material includes, but is not limited to, a carbon-based material, metal-based material, conductive polymer, or any combination thereof. In some embodiments, the carbon-based material may include, but is not limited to, natural graphite, artificial graphite, carbon black, acetylene black, Ketjen black, carbon fiber, or any combination thereof. In some embodiments, the conductive polymer may be a polyphenylene derivative.

The above secondary battery is applied to an electronic device to supply power to a load in the electronic device. Moreover, the above secondary battery containing the negative electrode plate exhibits excellent ITC cycling swelling performance, helping to prolong a service life of the electronic device. The electronic device may include, but is not limited to, laptops, pen-input computers, mobile computers, e-book readers, portable phones, portable fax machines, portable copiers, portable printers, headphones, video recorders, liquid crystal display televisions, handheld cleaners, portable CD players, mini discs, transceivers, electronic notebooks, calculators, memory cards, portable recorders, radios, backup power supplies, motors, cars, motorcycles, electric bicycles, bicycles, lighting equipment, toys, gaming consoles, clocks, power tools, flashlights, cameras, large household batteries, and lithium-ion capacitors.

The following describes this application through specific examples and comparative examples. Persons skilled in the art should understand that the preparation methods described in this application are only examples, and any other suitable preparation methods are within the scope of this application.

### Example 1-1

### (1) Preparation of Silicon-Carbon Particles

In an argon atmosphere, 100 g of a porous carbon scaffold (a particle size Dᵥ50 of porous carbon is 6 μm to 10 μm) was heated to 420° C. at a rate of 2° C./min, and the argon atmosphere was switched to a silane mixed gas (20% silane and 80% argon by mass). The first silicon deposition was performed at 420° C./200 sccm for 5 h. Then, the silane mixed gas atmosphere was switched to a carbon dioxide mixed gas (5% carbon dioxide and 95% argon by mass), and the first oxidation process was implemented at 400° C./50 sccm for 2.4 h. Subsequently, the carbon dioxide mixed gas atmosphere was switched to a silane mixed gas (20% silane and 80% argon by mass), and the second silicon deposition was performed at 420° C./200 sccm for 5 h. Finally, the silane mixed gas atmosphere was switched to a carbon dioxide mixed gas (5% carbon dioxide and 95% argon by mass), and the second oxidation process was implemented at 400° C./50 sccm for 2 h. In this way, a core was obtained.

The carbon dioxide mixed gas atmosphere was switched to an acetylene mixed gas (20% acetylene and 80% argon by mass) and deposition was continued at 500° C. for 10 h. Then, the acetylene mixed gas was switched to nitrogen, and the temperature was cooled to room temperature of 25° C. In this way, the silicon-carbon particles were obtained.

### (2) Preparation of Negative Electrode Plate

The negative electrode material (a mixture of artificial graphite and the above silicon-carbon particles at a weight ratio of 80:20), carbon nanotubes, polymethyl acrylate, and sodium carboxymethyl cellulose were mixed at a weight ratio of 97:1:1:1, deionized water was added as a solvent, and the mixture was prepared into a negative electrode slurry with a solid content of 40 wt %. The mixture was stirred uniformly in a vacuum mixer to obtain the negative electrode slurry. The negative electrode slurry was uniformly applied to one surface of a 12-μm negative electrode current collector copper foil and dried at 85° C. to obtain a negative electrode plate with a single coated with a negative electrode material layer, with a coating weight of the negative electrode material layer being 10 mg/cm². The above steps were repeated on another surface of the copper foil to obtain a negative electrode plate with two sides coated with a negative electrode material layer. Then, after cold pressing, cutting, and slitting, the plate was dried under vacuum at 120° C. for 12 h to obtain a negative electrode plate with a dimension of 78 mm×875 mm. Then, tabs were welded. A compacted density of the negative electrode material layer after cold pressing was 1.7 g/cm³. The negative electrode material included artificial graphite and the prepared silicon-carbon material, with a mass ratio of artificial graphite to silicon-carbon particles being 80:20.

### (3) Preparation of Positive Electrode Plate

The positive electrode active material lithium cobalt oxide, conductive carbon black Super P, and positive electrode binder polyvinylidene fluoride were mixed at a mass ratio of 97:1.4:1.6, N-methylpyrrolidone was added as a solvent, and the mixture was prepared into a positive electrode slurry with a solid content of 72 wt %. The mixture was stirred uniformly under vacuum to obtain the positive electrode slurry. The positive electrode slurry was uniformly applied to one surface of a 12-μm positive electrode current collector aluminum foil and dried at 85° C. to obtain a positive electrode plate with a single side coated with a positive electrode material layer, with a coating weight of the positive electrode material layer being 19 mg/cm². The above steps were repeated on another surface of the aluminum foil to obtain a positive electrode plate with two sides coated with a positive electrode material layer. Then, after cold pressing, cutting, and slitting, the plate was dried under vacuum at 85° C. for 4 h to obtain a positive electrode plate with a dimension of 74 mm×867 mm. Tabs were welded. A compacted density of the positive electrode material layer after cold pressing was 4.2 g/cm³.

### (4) Preparation of Electrolyte

In a dry argon environment, LiPF₆ was added to a mixed solution of 1,3-propane sultone (1,3-PS), propyl propionate (PP), ethyl propionate (EP), fluoroethylene carbonate (FEC), propylene carbonate (PC), and ethylene carbonate (EC). Based on a mass of the electrolyte, a mass percentage of LiPF₆ was 12.5%, a mass percentage of 1,3-PS was 3%, a mass percentage of PC was 8%, a mass percentage of EC was 10%, a mass percentage of FEC was 10%, and a balance was EP and PP, with a mass ratio of EP to PP being 1:3.

### (5) Preparation of Separator

A 7-μm porous polyethylene film (provided by Celgard) was used as the separator.

### (6) Preparation of Lithium-Ion Full Battery

The positive electrode plate, separator, negative electrode plate, and separator were stacked in order, with the separator positioned between the positive electrode plate and the negative electrode plate for separation, and wound to obtain an electrode assembly. The electrode assembly was placed in an aluminum-plastic film packaging bag, dried at 80° C., and then injected with the electrolyte. After vacuum encapsulation, resting, formation, shaping, and capacity testing processes, a pouch lithium-ion battery was obtained.

### (7) Preparation Method of Lithium-Ion Button Half-Cell

Preparation of negative electrode plate of button half-cell: Silicon-carbon particles, sodium carboxymethyl cellulose, and conductive carbon black were thoroughly mixed and stirred in an appropriate amount of deionized water at a weight ratio of 80:10:10 to form a uniform negative electrode slurry with a solid content of 40 wt %. The slurry was applied to a negative electrode current collector copper foil, and dried at 85° C. After cold pressing, cutting, and slitting, the copper foil was dried under vacuum at 120° C. for 12 h to obtain the negative electrode plate of the button half-cell.

Preparation of lithium-ion button half-cell: The electrolyte prepared in each example or comparative example was used as the electrolyte for the button half-cell. A 7-μm polypropylene/polyethylene composite separator was used. A lithium foil and the negative electrode plate for the button half-cell were used as counter electrodes, respectively. The button half-cells were assembled in a glovebox.

### Examples 1-2 to 1-11

Examples 1-2 to 1-11 differ from Example 1-1 in that the periods of the two carbon dioxide introduction processes were changed during the preparation of silicon-carbon particles. Other steps were the same as the steps in Example 1-1. Specific preparation parameters were shown in Table 1 and Table 2.

### Examples 2-1 to 2-14

Examples 2-1 to 2-14 differ from Example 1-1 in that the periods of the two carbon dioxide introduction processes were changed during the preparation of silicon-carbon particles. Other steps were the same as the steps in Example 1-1. Specific preparation parameters were shown in Table 3 and Table 4.

### Examples 2-15 to 2-18

Examples 2-15 to 2-18 differ from Example 2-4 in that the average circularities of the silicon-carbon particles and graphite particles in the negative electrode material were changed. Other steps were the same as the steps in Example 1-1. Specific preparation parameters were shown in Table 5.

### Comparative Example 1

Comparative example 1 differs from Example 1-1 in that the reaction temperature of carbon dioxide and the amount of introduced carbon dioxide during the second oxidation process were adjusted. Specific preparation parameters were shown in Table 1 and Table 2. Other steps were the same as the steps in Example 1-1.

### Comparative Example 2

Comparative example 2 differs from Example 1-1 in that the period of the first carbon dioxide oxidation process, the amount of introduced carbon dioxide, and the period of carbon dioxide introduction in the second oxidation process were adjusted. Specific preparation parameters were shown in Table 1 and Table 2. Other steps were the same as the steps in Example 1-1.

### Comparative Example 3

Comparative example 3 differs from Example 1-1 in that no carbon dioxide was introduced during the two oxidation processes. Specific preparation parameters were shown in Table 1 and Table 2. Other steps were the same as the steps in Example 1-1.

### Comparative Example 4

Comparative example 4 differs from Example 1-1 in that the introduction period and mass percentage of carbon dioxide in the first oxidation process were adjusted, and no second carbon dioxide oxidation process was implemented. Specific preparation parameters were shown in Table 1 and Table 2. Other steps were the same as the steps in Example 1-1.

### Examples 3-1 to 3-8

Examples 3-1 to 3-8 differ from Example 2-1 in that the components of the electrolyte in the lithium-ion battery were adjusted. The parameters of the relevant electrolyte components were adjusted according to Table 6. Other steps were the same as the steps in Example 2-1.

### Related Test Methods for Negative Electrode Material

### (1) Test Method for Oxygen Amount of Silicon-Carbon Particle

The oxygen amount was tested using a nitrogen-oxygen-hydrogen analyzer. A 0.2 g sample of silicon-carbon material particles was mixed uniformly with a flux (graphite), and placed in a graphite crucible in the instrument's sample injector. A high-temperature furnace was heated to 2500° C., and the silicon-carbon material particle sample was melted in an argon flow, releasing oxygen in the form of CO or CO₂. A carrier gas transported oxygen to a detection system. CO/CO₂ was detected by an infrared detector. Since absorbance is proportional to oxygen mass amount, the oxygen mass amount was obtained based on a data system.

### (2) Test Method for Oxygen Amount in Surface Region and Internal Region of Silicon-Carbon Material Particle

In an argon atmosphere, focused ion beam cutting (FIB) was used to section the silicon-carbon material particle to obtain a thin slice sample for analysis. The internal region and surface region of the silicon-carbon material particle was observed and identified using TEM. TEM-EDX was used to take multiple measurements (5 times, averaged) to obtain the oxygen mass amounts in the internal region and surface region of the silicon-carbon material particle.

### (3) Test Method for Differential Capacity Curve of Negative Electrode Material During Delithiation

The lithium-ion button half-cell was discharged to 0.005 V in three stages at small currents of 0.05 C/50 μA/10 μA, and a first discharge capacity of the lithium-ion button half-cell was recorded. Then, the cell was charged at a constant current of 0.1 C to 1.5 V, and the first charge capacity of the lithium-ion button half-cell was recorded. Herein, a first reversible specific capacity of the negative electrode material from 0.005 V to 1.5 V=first charge capacity of button battery/mass of negative electrode material. Then the specific capacity-voltage data pairs from the charge process were processed using the slope function (obtaining DQ/DV corresponding to each voltage), sampling one data point every 15 points. The differential capacity curve for the negative electrode material delithiation was plotted with voltage used as abscissa and DQ/DV used as ordinate.

### (4) Test Method for X-Ray Photoelectron Spectroscopy

XPS was used to analyze a composition of a surface Si layer of the silicon-carbon material particle. The silicon-carbon material particle was attached to a double-sided tape on a sample stage and placed in the sample chamber for testing.

Peak deconvolution calculation: a. The raw data were charge-corrected based on the standard value of adventitious carbon at 284.8 eV. b. Peak deconvolution fitting of the XPS spectra was conducted. Peak fitting rules: For split orbitals of the same element, the full width at half maximum should be kept as consistent as possible. The Gaussian-Lorentzian ratio for the data should remain consistent (typically set to the default value of 80). c. An integrated intensity ratio of the deconvoluted peaks in the spectrum were calculated using scientific graphing software (Origin).

### (5) Test Method for Average Circularities of Silicon-Carbon Material Particles and Graphite

A ZEISS-SEM (sigma-02-33) scanning electron microscope was used to observe particle samples of the negative electrode active material. Twenty silicon-carbon material particles (or graphite particles) were randomly selected, and respective perimeter-equivalent diameters and area-equivalent diameters were calculated, where the sphericity of each silicon-carbon material particle (or graphite)=perimeter-equivalent diameter/area-equivalent diameter. An arithmetic mean of the sphericities of the 20 silicon-carbon material particles (or graphite) was calculated and used as the sphericity of the silicon-carbon material particle (or graphite).

### Performance Test for Lithium-Ion Battery

### (1) Test for Capacity Per Gram/Initial Coulombic Efficiency

Test: the lithium-ion button half-cell was discharged to 0.005 V in three stages at small currents of 0.05 C/50 μA/10 μA, and the first discharge capacity of the lithium-ion button half-cell was recorded. Then, the cell was charged at a constant current of 0.1 C to 1.5 V, and the first charge capacity of the lithium-ion button half-cell was recorded. Herein, first reversible specific capacity of negative electrode material from 0.005 V to 1.5 V=first charge capacity of lithium-ion button half-cell/mass of negative electrode material.

### (2) ITC Cycling Swelling Test

At 45° C., the lithium-ion full battery was charged at a constant current density of 2 C to 4.28 V, then at a constant current density of 1.5 C to 4.45 V, followed by constant voltage charge until the current density reached 0.5 C. The battery was then charged at a constant current density of 0.5 C to 4.53 V, followed by constant voltage charge until the current density reached 0.05 C. In this case, the SOC of the lithium-ion full battery was 100%. The temperature was then kept for 24 h and the battery was discharged at a current density of 0.5 C to 3.0 V. This charge-discharge cycle was repeated 50 times. A pressure of 1000 g was applied to a surface of the lithium-ion battery, and a thickness of the lithium-ion battery was measured through PPG laser thickness measurement. A thickness of the fully-charged full battery after 50 cycles was T1. A thickness of the lithium-ion battery at half charge (50% SOC) was denoted as TO and used as the reference. Then the swelling rate was calculated as ITC cycling swelling rate=(T1−T0)/T0.

The preparation conditions and test results of the examples and comparative examples are recorded in Table 1 to Table 6.

TABLE 1

| | | Mass | | | | Mass | | |
|---|---|---|---|---|---|---|---|---|
| | Reaction | percentage | Flow rate | | Reaction | percentage | Flow rate | |
| | temperature | of CO₂ | of CO₂ | Period of | temperature | of CO₂ | of CO₂ | Period of |
| | of first | introduced | introduced | first CO₂ | of second | introduced | introduced | second CO₂ |
| | oxidation | in first | in first | introduction | oxidation | in second | in second | introduction |
| | process | process | process | process | process | process | process | process |
| | (° C.) | (%) | (sccm) | (h) | (° C.) | (%) | (sccm) | (h) |
| Example 1-1 | 400 | 5 | 50 | 2.4 | 400 | 5 | 50 | 2 |
| Example 1-2 | 400 | 5 | 50 | 4 | 400 | 5 | 50 | 4 |
| Example 1-3 | 400 | 5 | 50 | 8 | 400 | 5 | 50 | 8 |
| Example 1-4 | 400 | 5 | 50 | 2.2 | 400 | 5 | 50 | 2.3 |
| Example 1-5 | 400 | 5 | 50 | 4.2 | 400 | 5 | 50 | 3.8 |
| Example 1-6 | 400 | 5 | 50 | 8.1 | 400 | 5 | 50 | 6.2 |
| Example 1-7 | 400 | 5 | 50 | 4 | 400 | 5 | 50 | 1.1 |
| Example 1-8 | 400 | 5 | 50 | 4 | 400 | 5 | 50 | 1.5 |
| Example 1-9 | 400 | 5 | 50 | 4 | 400 | 5 | 50 | 4.3 |
| Example 1-10 | 400 | 5 | 50 | 4 | 400 | 5 | 50 | 6 |
| Example 1-11 | 400 | 5 | 50 | 4 | 400 | 5 | 50 | 9 |
| Comparative | 400 | 5 | 50 | 2 | 100 | 1 | 20 | 0.1 |
| example 1 | | | | | | | | |
| Comparative | 400 | 5 | 50 | 4 | 400 | 50 | 500 | 24 |
| example 2 | | | | | | | | |
| Comparative | 400 | / | / | / | 400 | / | / | / |
| example 3 | | | | | | | | |
| Comparative | 400 | 30 | 50 | 24 | 400 | / | / | / |
| example 4 | | | | | | | | |

TABLE 2

| | | Oxygen | Oxygen | | | ITC |
|---|---|---|---|---|---|---|
| | | amount in | amount in | | Initial | cycling |
| | Oxygen | internal | surface | Capacity | coulombic | swelling |
| | amount X | region X1 | region X2 | per gram | efficiency | rate |
| | (%) | (%) | (%) | (mAh/g) | (%) | (%) |
| Example 1-1 | 3 | 3.2 | 2.8 | 602 | 91.6 | 8.70 |
| Example 1-2 | 5 | 5.3 | 4.7 | 600 | 91.3 | 8.50 |
| Example 1-3 | 10 | 10 | 8 | 601 | 91.1 | 8.30 |
| Example 1-4 | 3.2 | 3 | 3.3 | 603 | 91.7 | 8.80 |
| Example 1-5 | 5.1 | 5.4 | 4.7 | 600 | 91.2 | 8.60 |
| Example 1-6 | 9.1 | 10 | 8.2 | 598 | 91 | 8.20 |
| Example 1-7 | 3.3 | 5 | 1.5 | 591 | 86.4 | 9.10 |
| Example 1-8 | 3.5 | 5 | 2 | 604 | 91.8 | 8.60 |
| Example 1-9 | 5 | 5 | 5 | 601 | 91.5 | 8.40 |
| Example 1-10 | 6.5 | 5 | 8 | 599 | 90.9 | 8.10 |
| Example 1-11 | 7.5 | 5 | 10.3 | 587 | 85.2 | 9.30 |
| Comparative | 1.4 | 3.2 | 0.4 | 563 | 82.7 | 11.70 |
| example 1 | | | | | | |
| Comparative | 15 | 5.5 | 25.7 | 554 | 82.1 | 12.90 |
| example 2 | | | | | | |
| Comparative | 0.4 | 0.4 | 0.5 | 580 | 83.7 | 13.60 |
| example 3 | | | | | | |
| Comparative | 8 | 15 | 0.6 | 576 | 84.1 | 11.80 |
| example 4 | | | | | | |

According to Table 1 and Table 2, compared with the comparative examples, in Examples 1-1 to 1-11, during the preparation of silicon-carbon particle materials, the periods of the two carbon dioxide introduction processes are changed. When the oxygen amount in the silicon-carbon particle and the oxygen amount in the internal region both meet specific ranges, the specific capacity and initial coulombic efficiency of the negative electrode material can be improved and the ITC cycling swelling of the secondary battery can be reduced.

In addition, when the oxygen amount in the surface region also meets specific range, the specific capacity and initial coulombic efficiency of the negative electrode material can be further improved and the ITC cycling swelling of the secondary battery can be mitigated.

TABLE 3

| | Period of | Period of | | Oxygen | Oxygen |
|---|---|---|---|---|---|
| | first CO₂ | second CO₂ | Oxygen | amount in | amount in |
| | introduction | introduction | amount | internal region | surface region |
| | process (h) | process (h) | X (%) | X1 (%) | X2 (%) |
| Example 1-1 | 2 | 2 | 3 | 3.2 | 2.8 |
| Example 1-2 | 4 | 4 | 5 | 5.3 | 4.7 |
| Example 1-3 | 8 | 8 | 10 | 10 | 8 |
| Example 1-4 | 2.2 | 2.3 | 3.2 | 3 | 3.3 |
| Example 1-5 | 4.2 | 3.8 | 5.1 | 5.4 | 4.7 |
| Example 1-6 | 8.1 | 7.9 | 9.1 | 10 | 8.2 |
| Example 1-7 | 4 | 1.1 | 3.3 | 5 | 1.5 |
| Example 1-8 | 4 | 1.5 | 3.5 | 5 | 2 |
| Example 1-9 | 4 | 4.3 | 5 | 5 | 5 |
| Example 1-10 | 4 | 6 | 6.5 | 5 | 8 |
| Example 1-11 | 4 | 8 | 7.5 | 5 | 10.3 |
| Example 2-1 | 2.2 | 4 | 4 | 3 | 4.7 |
| Example 2-2 | 4.5 | 4.5 | 6 | 6 | 5.8 |
| Example 2-3 | 3.5 | 8.5 | 6 | 4.5 | 9 |
| Example 2-4 | 2.5 | 4.5 | 4.8 | 3.6 | 6 |
| Example 2-5 | 4 | 1.5 | 3.6 | 5 | 2 |
| Example 2-6 | 4.3 | 1.5 | 3.8 | 5.6 | 2 |
| Example 2-7 | 4.5 | 8.7 | 7 | 6 | 9.5 |
| Example 2-8 | 4.4 | 6.5 | 7.1 | 5.8 | 8.4 |
| Example 2-9 | 4.2 | 4.8 | 5.8 | 5.4 | 6.5 |
| Example 2-10 | 2.4 | 1.5 | 3 | 3.2 | 2.1 |
| Example 2-11 | 2.5 | 1.6 | 3.1 | 3.5 | 2.2 |
| Example 2-12 | 4.5 | 3.6 | 4.6 | 6 | 4.2 |
| Example 2-13 | 4.5 | 4.7 | 6.4 | 6 | 6.4 |
| Example 2-14 | 9.5 | 5.9 | 9.7 | 9.8 | 7.9 |

TABLE 4

| | | Peak intensity | Peak | | | |
|---|---|---|---|---|---|---|
| | | ratio I1 of | intensity | | | ITC |
| | | differential | ratio I2 | | Initial | cycling |
| | | capacity | between | Capacity | coulombic | swelling |
| | | curve during | Si—O peak and | per gram | efficiency | rate |
| | X1/X2 | delithiation | Si—Si peak | (mAh/g) | (%) | (%) |
| Example 1-1 | 1.1 | 2.6 | 1.06 | 602 | 91.6 | 8.70 |
| Example 1-2 | 1.1 | 2.1 | 1.11 | 600 | 91.3 | 8.50 |
| Example 1-3 | 1.3 | 1.8 | 1.23 | 601 | 91.1 | 8.30 |
| Example 1-4 | 0.9 | 2.7 | 1.07 | 603 | 91.7 | 8.80 |
| Example 1-5 | 1.1 | 2.1 | 1.11 | 600 | 91.2 | 8.60 |
| Example 1-6 | 1.2 | 1.9 | 1.22 | 598 | 91 | 8.20 |
| Example 1-7 | 3.3 | 3.2 | 0.92 | 591 | 86.4 | 9.10 |
| Example 1-8 | 2.5 | 2.8 | 1.04 | 604 | 91.8 | 8.60 |
| Example 1-9 | 1.0 | 2.2 | 1.12 | 601 | 91.5 | 8.40 |
| Example 1-10 | 0.6 | 1.8 | 1.24 | 599 | 90.9 | 8.10 |
| Example 1-11 | 0.5 | 1.7 | 1.48 | 587 | 85.2 | 9.30 |
| Example 2-1 | 0.6 | 2.1 | 1.11 | 605 | 92.1 | 7.70 |
| Example 2-2 | 1.0 | 2.1 | 1.12 | 606 | 91.8 | 7.80 |
| Example 2-3 | 0.5 | 2.5 | 1.07 | 587 | 85.4 | 9.60 |
| Example 2-4 | 0.6 | 2.6 | 1.05 | 601 | 90.9 | 8.50 |
| Example 2-5 | 2.5 | 2.5 | 1.06 | 602 | 91.2 | 8.70 |
| Example 2-6 | 2.8 | 2.7 | 1.04 | 588 | 86.2 | 9.70 |
| Example 2-7 | 0.6 | 1.5 | 1.35 | 585 | 86.1 | 9.90 |
| Example 2-8 | 0.7 | 1.7 | 1.13 | 599 | 90.8 | 8.80 |
| Example 2-9 | 0.8 | 3.8 | 0.91 | 601 | 91.1 | 8.60 |
| Example 2-10 | 1.5 | 4 | 0.82 | 585 | 86.4 | 9.30 |
| Example 2-11 | 1.6 | 3.3 | 0.5 | 587 | 86.7 | 9.40 |
| Example 2-12 | 1.4 | 2.1 | 0.8 | 601 | 90.7 | 8.50 |
| Example 2-13 | 0.9 | 1.9 | 1.5 | 602 | 90.9 | 8.30 |
| Example 2-14 | 1.2 | 1.7 | 1.8 | 585 | 86.2 | 9.10 |

According to Table 3 and Table 4, in the above examples, during the preparation of the silicon-carbon particle material, the periods of the two carbon dioxide introduction processes are changed. When the ratio X1/X2 of the silicon-carbon particle, the differential capacity curve of the negative electrode material, and the ratio of the Si—O peak to the Si—Si peak are within respective specific ranges, the capacity per gram and initial coulombic efficiency of the negative electrode material can be further improved and the ITC cycling swelling of the secondary battery can be mitigated.

TABLE 5

| | | Circularity | | | Initial | |
|---|---|---|---|---|---|---|
| | Circularity of | of particles | | Capacity | coulombic | ITC cycling |
| | silicon-carbon | of the | \|C1 − | per gram | efficiency | swelling rate |
| | particles C1 | graphite C2 | C2\| | (mAh/g) | (%) | (%) |
| Example 2-4 | 0.7 | 0.8 | 0.1 | 601 | 90.9 | 8.50 |
| Example 2-15 | 0.8 | 0.8 | 0 | 604 | 92.1 | 7.80 |
| Example 2-16 | 0.65 | 0.8 | 0.15 | 598 | 90.4 | 8.60 |
| Example 2-17 | 0.6 | 0.8 | 0.2 | 596 | 90.1 | 8.80 |

In Table 5, during the preparation of the negative electrode material, when the difference in the average circularities of graphite and silicon-carbon particles satisfies a specific range, the specific capacity and initial coulombic efficiency of the negative electrode material can be further improved and the ITC cycling swelling of the secondary battery can be mitigated.

TABLE 6

| | Ethylene | Propylene | | | | | Initial | |
|---|---|---|---|---|---|---|---|---|
| | carbonate | carbonate | Fluoroethylene | | | Capacity | coulombic | ITC cycling |
| | D1 | D2 | carbonate D3 | D1 + | | per gram | efficiency | swelling rate |
| | (%) | (%) | (%) | D2 | D3/D1 | (mAh/g) | (%) | (%) |
| Example 2-1 | 10 | 8 | 10 | 18 | 1.00 | 605 | 92.1 | 7.7 |
| Example 3-1 | 5 | 4 | 5 | 9 | 1.00 | 604 | 90.6 | 9.0 |
| Example 3-2 | 10 | 2 | 10 | 12 | 1.00 | 604 | 91.8 | 8.5 |
| Example 3-3 | 12 | 13 | 12 | 25 | 1.00 | 605 | 91.4 | 8.1 |
| Example 3-4 | 12 | 23 | 12 | 35 | 1.00 | 605 | 90.1 | 8.8 |
| Example 3-5 | 12 | 8 | 10 | 20 | 0.83 | 605 | 90.7 | 8.6 |
| Example 3-6 | 8 | 8 | 12 | 16 | 1.50 | 604 | 91.7 | 8.0 |
| Example 3-7 | 8 | 8 | 14 | 16 | 1.75 | 605 | 91.2 | 8.3 |
| Example 3-8 | 8 | 8 | 16 | 16 | 2.00 | 604 | 89.9 | 9.3 |

According to Table 6, when the electrolyte contains ethylene carbonate and propylene carbonate, the sum of the mass percentages D1+D2 satisfies an appropriate range, the electrolyte contains ethylene carbonate and fluoroethylene carbonate, and the mass ratio D3/D1 satisfies an appropriate range, the initial coulombic efficiency of the negative electrode material can be further improved and the ITC cycling swelling of the secondary battery is reduced while an excellent specific capacity is maintained.

The above disclosure is only preferred embodiments of this application and should not be used to limit this application. Therefore, equivalent changes made in accordance with this application are still within the scope of this application.

What is claimed is:

1. A negative electrode material, comprising silicon-carbon particles, wherein an oxygen amount in the silicon-carbon particles is X %, wherein 3≤X≤10, each silicon-carbon particle comprises an internal region and a surface region, the surface region is a region within a distance of less than 20 nm from a surface of the each silicon-carbon particle, the internal region is a region in the each silicon-carbon particle other than the surface region, and an oxygen amount in the internal region is X1%, wherein 3≤X1≤10.

2. The negative electrode material according to claim 1, wherein the silicon-carbon particles comprise porous carbon and silicon particles, and at least a part of the silicon particles is located within pores of the porous carbon.

3. The negative electrode material according to claim 1, wherein an oxygen amount in the surface region is X2%, wherein 2≤X2≤8.

4. The negative electrode material according to claim 3, wherein 0.6≤X1/X2≤ 2.5.

5. The negative electrode material according to claim 1, wherein the negative electrode material satisfies at least one of the following conditions:
$$4 \leq X \leq 6 and 3 \leq X 1 \leq 6 ; \qquad ( 1 )$$
(2) a delithiation differential capacity curve of the negative electrode material exhibits a first peak in the range of 200 mV to 320 mV and a second peak in the range of 600 m V to 900 mV, wherein a peak intensity ratio of the first peak to the second peak satisfies is I1, 1.7≤I1≤3.8; or
(3) in an X-ray photoelectron spectrum of the silicon-carbon particle, a Si—O peak is present in the range of 101 eV to 104 eV and a Si—Si peak is present in the range of 96 eV to 99 eV, wherein a peak intensity ratio of the Si—O peak to the Si—Si peak is I2, 0.8≤I2≤1.5.

6. A method of preparing the silicon-carbon particles in the negative electrode material according to claim 1, the method comprising following steps:
(S1) providing a porous carbon scaffold, introducing a silane gas into the porous carbon scaffold to deposit the silicon in the porous carbon scaffold, then sequentially switching the silane gas to a carbon dioxide mixed gas, the silane gas, and the carbon dioxide mixed gas, to obtain a core, wherein in each introduction process, a flow rate of the carbon dioxide mixed gas is 50 sccm to 300 sccm, an introduction period is 1 h to 20 h, a reaction temperature is 400° C. to 500° C., the carbon dioxide mixed gas contains carbon dioxide and an inert gas, and base on a mass of the carbon dioxide mixed gas, a mass percentage of carbon dioxide is 2% to 20%; and
(S2) introducing an alkane gas into the core to form a carbon layer on the core, so as to obtain the silicon-carbon particles.

7. A secondary battery, comprising a negative electrode plate, a positive electrode plate, and an electrolyte; wherein the negative electrode plate comprises a negative electrode material, wherein the negative electrode material comprises silicon-carbon particles, wherein an oxygen amount in the silicon-carbon particle is X %, wherein 3≤X≤10, each silicon-carbon particle comprises an internal region and a surface region, the surface region is a region within a distance of less than 20 nm from a surface of each silicon-carbon particle, the internal region is a region in each silicon-carbon particle other than the surface region, and an oxygen amount in the internal region is X1%, wherein 3≤X1≤10,
and the negative electrode material further comprises graphite.

8. The secondary battery according to claim 7, wherein the silicon-carbon particles comprise porous carbon and silicon particles, and at least a part of the silicon particles is located within pores of the porous carbon.

9. The secondary battery according to claim 7, wherein an oxygen amount in the surface region is X2%, wherein 2≤X2≤8.

10. The secondary battery according to claim 7, wherein 0.6≤X1/X2≤2.5.

11. The secondary battery according to claim 7, wherein 4≤X≤6 and 3≤X1≤6.

12. The secondary battery according to claim 7, wherein a delithiation differential capacity curve of the negative electrode material exhibits a first peak in the range of 200 mV to 320 mV and a second peak in the range of 600 mV to 900 mV, wherein a peak intensity ratio of the first peak to the second peak satisfies is I1, 1.7≤I1≤3.8.

13. The secondary battery according to claim 7, wherein in a X-ray photoelectron spectrum of the silicon-carbon particle, a Si—O peak is present in the range of 101 eV to 104 eV and a Si—Si peak is present in the range of 96 eV to 99 eV, wherein a peak intensity ratio of the Si—O peak to the Si—Si peak is I2, 0.8≤I2≤1.5.

14. The secondary battery according to claim 7, wherein an average circularity of the silicon-carbon particles is C1, an average circularity of particles of the graphite is C2, and |C1−C2|≤0.2.

15. The secondary battery according to claim 7, wherein the electrolyte satisfies at least one of the following conditions:
(1) the electrolyte comprises ethylene carbonate and propylene carbonate, and based on a mass of the electrolyte, a mass percentage of ethylene carbonate is D1%, and a mass percentage of propylene carbonate is D2%, wherein 9≤D1+D2≤35; or
(2) the electrolyte comprises ethylene carbonate and fluoroethylene carbonate, and based on a mass of the electrolyte, a mass percentage of the ethylene carbonate is D1%, and a mass percentage of the fluoroethylene carbonate is D3%, wherein 0.83≤D3/D1≤1.75.

16. The secondary battery according to claim 15, wherein the electrolyte satisfies at least one of the following conditions:
$$12 \leq D 1 + D 2 \leq 25 ; \qquad ( 1 )$$
$$or$$
$$1 \leq D 3 / D 1 \leq 1.5 . \qquad ( 2 )$$

17. An electronic device, comprising the secondary battery; wherein the secondary battery comprises a negative electrode plate, a positive electrode plate, and an electrolyte, wherein the negative electrode plate comprises a negative electrode material, wherein the negative electrode material comprises silicon-carbon particles, wherein an oxygen amount of the silicon-carbon particle is X %, wherein 3≤X≤10, the silicon-carbon particle comprises an internal region and a surface region, the surface region is a region within a distance of less than 20 nm from a surface of the silicon-carbon particle, the internal region is a region in the silicon-carbon particle other than the surface region, and an oxygen amount in the internal region is X1%, wherein 3≤X1≤10,
and the negative electrode material further comprises graphite.

18. The electronic device according to claim 17, wherein 0.6≤X1/X2≤2.5.

19. The electronic device according to claim 17, wherein an average circularity of the silicon-carbon particles is C1, an average circularity of particles of the graphite is C2, and |C1−C2|≤0.2.

20. The electronic device according to claim 17, wherein the electrolyte satisfies at least one of the following conditions:
(1) the electrolyte comprises ethylene carbonate and propylene carbonate, and based on a mass of the electrolyte, a mass percentage of ethylene carbonate is D1%, and a mass percentage of propylene carbonate is D2%, wherein 9≤D1+D2≤35; or
(2) the electrolyte comprises ethylene carbonate and fluoroethylene carbonate, and based on a mass of the electrolyte, a mass percentage of the ethylene carbonate is D1%, and a mass percentage of the fluoroethylene carbonate is D3%, wherein 0.83≤D3/D1≤1.75.
